(19) United States
(12) Patent Application Publication
(10) Pub. No.: US 2004/0075876 A1
(43) Pub. Date: Apr. 22, 2004

(54) Image reading apparatus and image forming apparatus

(75) Inventor: Toshiaki Amano, Chigasaki-Shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/273,355

(22) Filed: Oct. 18, 2002

(51) Int. Cl. H04N 1/04; H04N 1/46

(52) U.S. Cl. 358/509; 358/474

(57) ABSTRACT

An image reading apparatus includes a platen glass on which a document is placed, a light source which irradiates the document with a light beam via the platen glass, an imaging element which receives the light beam reflected from the document, so as to output an image signal, and an illuminance adjusting mechanism which adjusts the illuminance on a light receiving surface of the document by varying a distance between the light source and the platen glass while maintaining the number of light sources.

### BACKGROUND OF THE INVENTION

1. Field of the Invention

The present invention relates to an image reading apparatus and an image forming apparatus.

2. Related Background Art

An image forming apparatus such as a copying machine is mostly provided with an image reading apparatus which reads a document. Some of image reading apparatuses provided in a color copying machine use a 4-line CCD sensor. The 4-line CCD sensor includes a line CCD sensor for a light beam of a K (black) color in addition to a 3-line CCD sensor for taking in respective light beams of R (red), G (green) and B (blue) colors in accordance with three primary colors of light beams.

In the case where the 4-line CCD sensor is used, since light beams reflected from a document are taken in via color filters at the time of a color copying operation (in which reading is performed by respective sensors of R, G and B), the sensitivity of each of the sensors is degraded. Consequently, in the case where a reading speed (i.e., a scanning speed) at the time of the color copying operation is substantially the same as that at the time of a monochromatic copying operation, it is necessary to set illuminance on the document surface at the time of the color copying operation higher than that at the time of the monochromatic copying operation (in which only the K sensor performs reading).

In order to prevent any degradation of the sensitivity of the sensor at the time of the color copying operation, there have been conventionally conceived the following three means:

(1) a reading speed at the time of the color copying operation is made different from that at the time of the monochromatic copying operation;

(2) there are provided two light sources, both of which are lighted at the time of the color copying operation while only one of which is lighted at the time of the monochromatic copying operation; and

(3) light sources are manually attached and detached such that, for example, one of two light sources is detached or a reflecting mirror is disposed in addition to the other light source in order to achieve illuminances suitable for both of the color copying operation and the monochromatic copying operation.

However, there have arisen problems in the above-described means, respectively, as follows:

(1) since the reading speed at the time of the color copying operation becomes slower than that at the time of the monochromatic copying operation, a copying speed at the time of the color copying operation becomes slow;

(2) a cost becomes high since the two light sources are provided, and further, the temperature around the light sources is increased by the use of the two light sources; and

(3) a cumbersome work is required for manually attaching and detaching the light source, which is very inconvenient.

### BRIEF SUMMARY OF THE INVENTION

An object of the present invention is to provide an image reading apparatus capable of varying illuminance on a document surface with a simple configuration, and an image forming apparatus provided with the same.

According to a first aspect of the present invention, there is provided an image reading apparatus comprising: a platen glass on which a document is placed; a light source which irradiates the document with a light beam via the platen glass; an imaging element which receives the light beam reflected from the document, so as to output an image signal; and an illuminance adjusting mechanism which adjusts the illuminance on a light receiving surface of the document by varying a distance between the light source and the platen glass while maintaining the number of light sources.

According to a second aspect of the present invention, there is provided an image forming apparatus comprising an image reading apparatus including: a platen glass on which a document is placed; a light source which irradiates the document with a light beam via the platen glass; an imaging element which receives the light beam reflected from the document, so as to output an image signal; and an illuminance adjusting mechanism which adjusts the illuminance on a light receiving surface of the document by varying a distance between the light source and the platen glass while maintaining the number of light sources.

### BRIEF DESCRIPTION OF THE DRAWINGS

In the attached drawings,

FIG. 1 is a cross-sectional view showing an image reading apparatus in an embodiment according to the present invention; and

FIG. 2 is a cross-sectional view showing, in more detail, a light source unit provided in the image reading apparatus shown in FIG. 1.

### DETAILED DESCRIPTION OF THE INVENTION

An image reading apparatus in an embodiment according to the present invention will be described below in reference to the accompanying drawings.

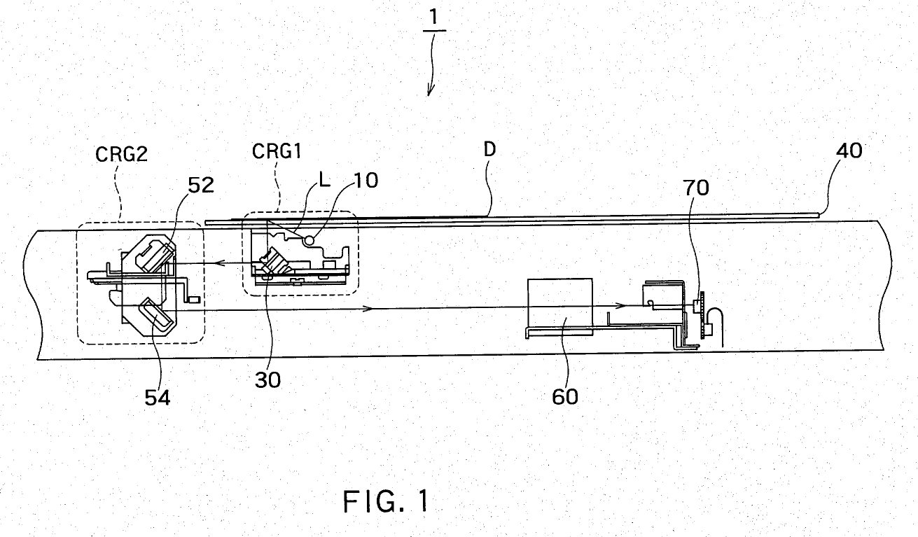

FIG. 1 is a cross-sectional view showing an image reading apparatus in an embodiment according to the present invention. An image reading apparatus 1 shown in FIG. 1 comprises a platen glass 40 on which a document D is placed, a carriage CRG 1 including an exposure lamp 10 and a mirror 30, another carriage CRG 2 including mirrors 52 and 54, a lens 60, and a 4-line CCD sensor 70. At the time of a copying operation, the exposure lamp 10 emits a light beam L, with which the document D is irradiated via the platen glass 40. The light beam reflected from the document D enters into the lens 60 through the mirrors 30, 52 and 54. The reflected light beam passing through the lens 60 enters the 4-line CCD sensor 70, so that an image at the surface of the document D is picked up, and thus, is output as an image signal.

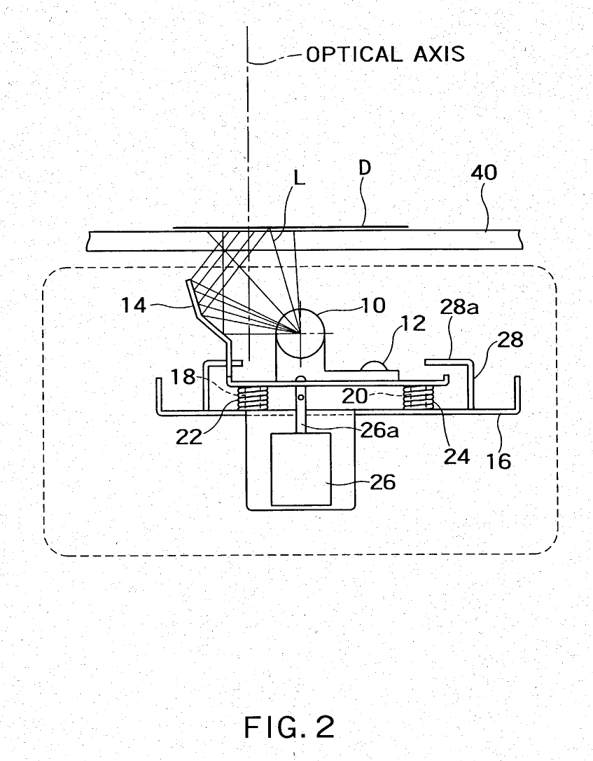

FIG. 2 is a cross-sectional view showing, in more detail, the configuration of a light source unit in the carriage CRG 1 in the image reading apparatus shown in FIG. 1. The light source unit shown in FIG. 2 includes the exposure lamp 10, a reflecting plate 14, a base 16 disposed under the reflecting plate 14, and a solenoid 26 disposed under the base 16. The exposure lamp 10 is fixed to the reflecting plate 14 via a screw 12. A distal end of a shaft 26a of the solenoid 26 is hooked on the reflecting plate 14. The solenoid 26 is switched on/off according to the selection of a copying mode which is determined by depressing a copy button (not shown). Specifically, the solenoid 26 is turned on at the time of a monochromatic copying operation; in contrast, it is turned off at the time of a color copying operation. At the upper surface of the base 16 are disposed guide rods 18 and 20 in a predetermined height. On compression springs 22 and 24 fitted around the guide rods, respectively, are mounted the reflecting plate 14. The guide rods 18 and 20 function as a first stopper, and therefore, distal ends thereof prevent the reflecting plate 14 from being descended (i.e., from being moved in a direction reverse to the platen glass) when the reflecting plate 14 is descended by turning the solenoid 26 on. At the peripheral edge of the base 16, there is provided a stopper 28 serving as a second stopper. The stopper 28 has a locking portion 28a extending in a predetermined height toward the reflecting plate 14 in a horizontal direction. When the solenoid 26 is turned off, the reflecting plate 14 is elevated by the extensile force of the compression springs 22 and 24 (i.e., is moved toward the platen glass). However, the locking portion 28a locks the peripheral edge of the reflecting plate 14 so as to prevent the reflecting plate 14 from being elevated. In this manner, the reflecting plate 14 can be vertically moved between an upper limit position and a lower limit position which are defined by these stoppers.

FIG. 2 shows the state of the light source unit at the time of the monochromatic copying operation. Specifically, the solenoid 26 is turned on at the time of the monochromatic copying operation, and the reflecting plate 14 is descended down while the compression springs 22 and 24 are compressed. The reflecting plate 14 is stopped at a position at which its lower surface abuts against the distal ends of the guide rods 18 and 20. In the meanwhile, the solenoid 26 is turned off at the time of the color copying operation, so that the reflecting plate 14 is elevated by the extension of the compression springs 22 and 24, and then, is stopped at the position of the locking portion 28a of the stopper 28. Consequently, the document D is brightly irradiated more than at the time of the monochromatic copying operation.

As described above, according to the image reading apparatus in the present embodiment, the document surface can be irradiated at different illuminances by the single light source by simply selecting the copying mode without any need of a cumbersome work such as a disassembling work, and further, the illuminance on the document surface can be adjusted with the simple configuration.

It is to be understood that the image reading apparatus in the above-described embodiment can be applied to an image forming apparatus such as a copying machine or a printer.

Although one embodiment according to the present invention has been described above, the present invention is not limited to the above-described embodiment, but can be applied to various embodiments within the spirit and scope of the present invention, claimed in the appended claims.

What is claimed is:

1. An image reading apparatus comprising:
a platen glass on which a document is placed;
a light source which irradiates the document with a light beam via the platen glass;
an imaging element which receives the light beam reflected from the document, so as to output an image signal; and
an illuminance adjusting mechanism which adjusts the illuminance on a light receiving surface of the document by varying a distance between the light source and the platen glass while maintaining the number of light sources.

2. An image reading apparatus according to claim 1, wherein said illuminance adjusting mechanism includes an actuator which moves the light source in a direction perpendicular to the platen glass depending on selection to a monochromatic copying mode or a color copying mode.

3. An image reading apparatus according to claim 2, wherein said illuminance adjusting mechanism further includes a first stopper separated by a first distance from the platen glass and a second stopper separated by a second distance shorter than the first distance from the platen glass,
the first stopper stopping the movement of the light source away from the platen glass in the vertical direction at a position from the platen glass by the first distance when the monochromatic copying mode is selected, and
the second stopper stopping the movement of the light source approaching the platen glass in the vertical direction at a position from the platen glass by the second distance when the color copying mode is selected.

4. An image reading apparatus according to claim 3, which further comprises:
a reflecting plate which mounts the light source thereon and reflects a light beam emitted from the light source toward the document,
wherein said illuminance adjusting mechanism further includes a base having guide rods disposed on a surface opposite to the reflecting plate, and resilient members fitted around the guide rods and interposed between the base and the reflecting plate, and
the guide rods are arranged with the distal ends thereof being apart by the second distance from the platen glass, so as to function as the first stopper.

5. An image forming apparatus comprising an image reading apparatus including:
a platen glass on which a document is placed;
a light source which irradiates the document with a light beam via the platen glass;
an imaging element which receives the light beam reflected from the document, so as to output an image signal; and
an illuminance adjusting mechanism which adjusts the illuminance on a light receiving surface of the document by varying a distance between the light source and the platen glass while maintaining the number of light sources.

6. An image forming apparatus according to claim 5, wherein said illuminance adjusting mechanism includes an actuator which moves the light source in a direction perpendicular to the platen glass depending on selection to a monochromatic copying mode or a color copying mode.

7. An image forming apparatus according to claim 6, wherein said illuminance adjusting mechanism further includes a first stopper separated by a first distance from the platen glass and a second stopper separated by a second distance shorter than the first distance from the platen glass,
the first stopper stopping the movement of the light source away from the platen glass in the vertical direction at a position from the platen glass by the first distance when the monochromatic copying mode is selected, and
the second stopper stopping the movement of the light source approaching the platen glass in the vertical direction at a position from the platen glass by the second distance when the color copying mode is selected.

8. An image forming apparatus according to claim 7, which further comprises:
a reflecting plate which mounts the light source thereon and reflects a light beam emitted from the light source toward the document,
wherein said illuminance adjusting mechanism further includes a base having guide rods disposed on a surface opposite to the reflecting plate, and resilient members fitted around the guide rods and interposed between the base and the reflecting plate, and
the guide rods are arranged with the distal ends thereof being apart by the second distance from the platen glass, so as to function as the first stopper.
